(19) United States
(12) Patent Application Publication
(10) Pub. No.: US 2016/0288234 A1
(43) Pub. Date: Oct. 6, 2016

(54) CERAMIC BACKING TILE WITH CONSUMABLE INSERT

(71) Applicant: Caterpillar Inc., Peoria, IL (US)

(72) Inventors: Leon Adcock, Chillicothe, IL (US); Huijun Wang, Peoria, IL (US); Howard Ludewig, Groveland, IL (US)

(73) Assignee: Caterpillar Inc., Peoria, IL (US)

(21) Appl. No.: 14/675,996

(22) Filed: Apr. 1, 2015

(51) Int. Cl. B23K 9/035; B23K 37/06; B23K 37/04

(52) U.S. Cl. CPC B23K 9/035; B23K 37/0461; B23K 37/06

(57) ABSTRACT

A weld backing assembly includes a backing tile configured to be applied to the underside of a seam between adjacent edges of two spaced-apart metal articles to be welded together. The backing tile is further configured to be aligned beneath the seam between the adjacent edges of the articles to support molten weld metal. The weld backing assembly also includes a consumable metal insert including an elongate strip embedded into a longitudinal center channel of the backing tile and one or more lateral strips embedded into corresponding lateral channels formed within the top surface of the backing tile.

### TECHNICAL FIELD

The present disclosure relates to weld backings and more specifically to a ceramic weld backing assembly including a consumable insert.

### BACKGROUND

Metal components can be joined together by a welding operation. For example two metal components may be positioned in a spaced apart relationship. The two components may then be welded together during a welding process, where molten weld material fills the space between the metal components, adheres to the components and cools. Through this process, the metal components are joined together.

Welding large open root gaps often requires use of a backing material to support the molten weld puddle during welding. For instance, pads of inert material, such as ceramic tiles, are often used to support the weld puddle during root pass welding. However, ceramic is non-conductive and therefore can be problematic when welding. Namely, because of the low thermal conductivity of ceramic material, the ceramic tiles are typically unable to rapidly dissipate the heat of the weld pool and accelerate its solidification. Moreover, if continuity of the process is not provided, the welding arc tends to directly strike the surface of the tiles and form small surface pitting thereon. Accordingly, the tiles may wear rapidly and require frequent maintenance and replacement.

Korean Patent Application 20120501263 to Goo discloses an electro-gas welding method used to reduce the time required for welding by simultaneously melting an insert wire and a filler metal wire by arc heat. The electro-gas welding method includes attaching a wire to an inner surface of a backing material and generating, using a welding torch, arc heat that melts a filler metal wire and the wire at the same time. However, Goo does not disclose a ceramic backing tile that includes a thin flat consumable insert embedded into a top layer of the ceramic backing tile.

The disclosed devices and methods are directed to solve one or more of the problems set forth above and/or other problems in the art.

### SUMMARY

In one embodiment, a weld backing assembly is disclosed. The weld backing assembly includes a backing tile configured to be applied to the underside of a seam between adjacent edges of two spaced-apart metal articles to be welded together. The backing tile is further configured to be aligned beneath the seam between the adjacent edges of the articles to support molten weld metal. The backing tile includes a centrally aligned longitudinal center channel formed within a center region of a top layer of the backing tile and one or more lateral channels formed within the top layer of the backing tile. The weld backing assembly also includes a consumable metal insert including an elongate strip embedded into the longitudinal center channel of the backing tile and one or more lateral strips embedded into corresponding lateral channels formed within the top surface of the backing tile.

In one embodiment, a method for forming a weld backing assembly is disclosed. The method may include forming a backing tile assembly configured to be applied to the underside of a seam between adjacent edges of two spaced-apart metal articles which are to be welded together. The backing tile assembly includes a plurality of backing tiles and further configured to be aligned beneath the seam between the adjacent edges of the articles to support molten weld metal. The method may also include forming a centrally aligned elongate channel spanning the length of the backing tile assembly and forming a plurality of transverse channels. Forming a plurality of transverse channels may include forming at least one transverse channel within an upper region of the top layer of at least one of the plurality of backing tiles and forming at least one transverse channel within a lower region of the top layer of at least one of the plurality of backing tiles. The method may further include forming a consumable metal insert configured to be embedded into the top layer of the backing tile assembly. Forming the consumable metal insert may also include forming an elongate strip configured to be embedded into the centrally aligned elongate channel and forming one or more lateral strips configured to be embedded into corresponding lateral channels formed within the top layer of at least one of the plurality of individual backing tiles. The method may then include embedding the consumable metal insert into the top layer of at least one of the plurality of individual backing tiles.

In one embodiment, a weld backing assembly includes a backing tile assembly configured to be applied to the underside of a seam between adjacent edges of two spaced-apart metal articles which are to be welded together. The backing tile assembly is further configured to be aligned beneath the seam between the adjacent edges of the articles to support molten weld metal. The backing tile assembly includes a centrally aligned elongate channel spanning the length of the backing tile assembly and one or more transverse channels formed within a top layer of the backing tile assembly. In some embodiments, a first transverse channel may be formed within a top layer of a first backing tile and a second transverse channel may be formed within a top layer of a second backing tile that is spaced apart from the first backing tile by at least a third backing tile. The weld backing assembly may also include a consumable metal insert embedded into the top layer of the backing tile. The consumable metal insert may include an elongate strip configured to be embedded into the centrally aligned elongate channel and one or more lateral strips configured to be embedded into corresponding transverse channels formed within the first and second the backing tiles.

### BRIEF DESCRIPTION OF THE DRAWINGS

The accompanying drawings, which are incorporated in and constitute a part of this specification, illustrate several aspects of the disclosure and together with the description, serve to explain the principles of the disclosure. In the drawings:

FIG. 1 illustrates an isometric view of a weld backing assembly according to exemplary embodiments of the present disclosure;

FIG. 2 illustrates an exploded isometric view of a weld backing assembly according to exemplary embodiments of the present disclosure;

FIG. 3 illustrates a exploded view of a weld backing assembly and metal components according to exemplary embodiments of the present disclosure;

FIG. 4 illustrates a cross-sectional view of a weld backing assembly and metal components according to exemplary embodiments of the present disclosure; and

FIG. 5 is a flow diagram illustrating a method of manufacturing a weld backing assembly according to exemplary embodiments of the present disclosure.

### DETAILED DESCRIPTION

The present disclosure relates to an apparatus for use during a welding process and a method of manufacturing such an apparatus. By means of the improvements embodied in the present disclosure, which will be described subsequently more fully, the operative procedures and effectiveness of the weld will be greatly augmented.

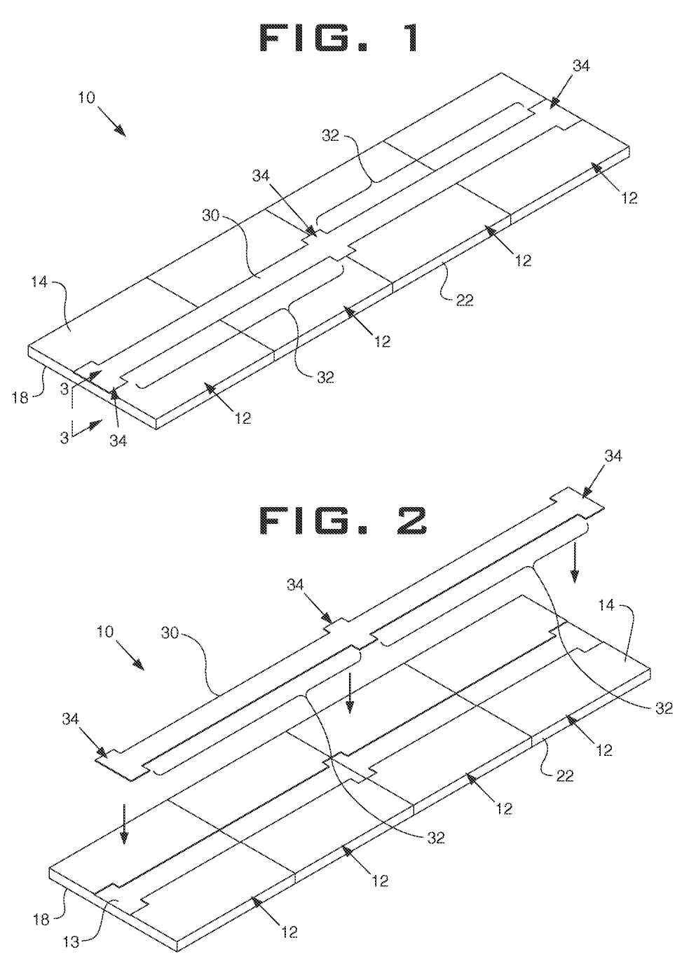

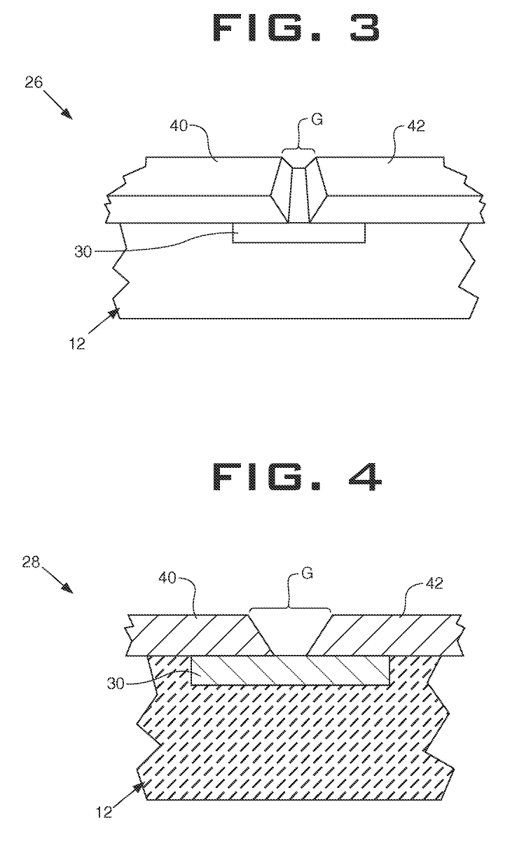

Referring to FIGS. 1 and 2, a backing assembly 10 for use during a welding process according to an embodiment of the disclosure is shown. The backing assembly 10 can be used for general welding. For instance, a welding process may include welding the ends of one or more metal components together such as, but not limited to, two generally planar metal plates, at the open root between the edges of the metal components. The backing assembly 10 can also be used with most types of welding equipment, including electric arc welding equipment such as MIG, TIG, and submerged arc equipment.

The backing assembly 10 may include a plurality of individual backing tiles 12 (referred to hereinafter as backing tiles 12 or backing tile assembly 12). In some embodiments, the backing tile assembly 12 may be a plurality of wafer like blocks arranged as a row of ceramic blocks forming several laterally closed passages. Each of the backing tiles 12 may have a substantially flat cuboid shape, which provides a top surface 14, as well as a bottom surface (not shown). A first lateral edge surface 18, a second lateral edge surface (not shown), a first longitudinal edge surface 22, and a second longitudinal edge surface (not shown). The shape, size and dimensions of the individual backing tiles 12 may vary. The backing tiles 12 may be made of a wide variety of ceramic refractories, such as alumina, magnesia, zirconia, chromite, mullite, zirconium silicate, fireclay or the like, alone or in combination. At least a portion of the plurality of the backing tiles 12 may also include a consumable insert 30.

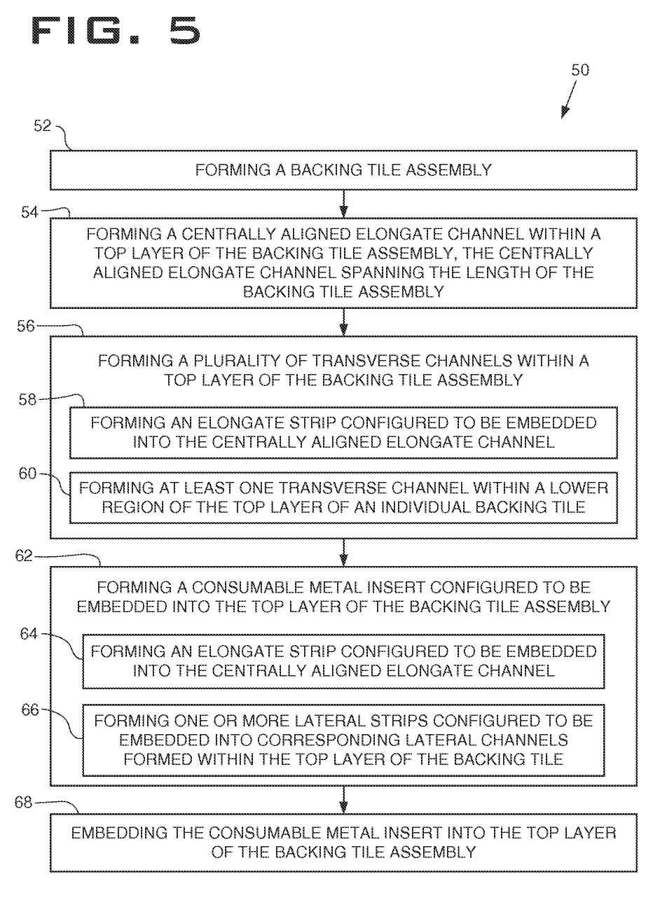

The backing assembly 10 may be specifically configured for shielding the underside of a weldment joint during welding. Referring to FIGS. 3 and 4, an exploded view 26 and a cross-sectional view 28 of metal component sections 40, 42 in use with the backing assembly 10 are shown. The metal component edges may be spaced apart such that gap G exists between the metal component edges. The width of the gap G is typically about 1-5 mm at the narrowest (and often ±1 mm apart), and 10-30 mm at the widest, although gap thickness may vary. The disclosed embodiments may preferably be utilized when the gap is larger (e.g., 5-10 mm) The thickness of the metal forming each metal component may be at least about 2 mm and is typically about 4-20 mm; however, other thicknesses can be used. The metal component sections 40, 42 may have adjacent opposed edges that include a beveled surface. In some welding processes, the edges of components that are to be connected by the weld may be beveled to provide a generally v-shaped groove with a wide opening on the front surface of the welded components and a more narrow opening on the back surface of the welded components for receiving the melted welding material. However, for the purposes of this disclosure, the use of a bevel is not required. For instance, in other embodiments, the end surfaces of the metal articles can have other profile shapes, such as, for example, those that would provide a “u,” “double u,” “double v,” etc., type butt joint.

In the above described types of welding configurations, the backing assembly 10 may be adapted to be applied to the underside of a seam between the adjacent opposed edges of two metal component sections 40, 42 to be welded, and serves to support and form the molten weld metal during welding. In preferred embodiments, the backing assembly 10 may be used for welding large gaps (e.g., where a space of more than 4 mm exits between metal articles to be welded). In all embodiments, the backing assembly 10 may be mounted centrally over the root gap.

The consumable insert 30 may be one or a series of thin (e.g., about 1 mm thick), flexible metallic strips that extend substantially longitudinally along the center of the backing tiles 12. In preferred embodiments, at least a portion of the consumable insert 30 spans the gap G between the two objects being welded.

The consumable insert 30 may be embedded into one or more of the backing tiles 12. In preferred embodiments, the consumable insert 30 may be embedded into a top layer of one or more backing tiles 12. To accommodate the consumable insert 30, each of plurality of backing tiles 12 may include a an elongated channel 13, which may be pre-formed in the individual backing tiles 12, or may be formed by etching, grinding or otherwise eroding a top layer of the backing tile 12 to form the channel 13. In some embodiments, the thickness of the consumable insert 30 is substantially equal to the thickness of the backing tiles 12. The elongated channel 13 may be a longitudinal channel spanning a central lengthwise region of the backing tiles 12 and a plurality of transverse channels positioned at predetermined intervals along the length of a grouping of backing tiles 12. Accordingly, the consumable insert 30 (e.g., formed as a continuous piece) may be inserted into the elongated channel 13 of the backing tile 12 such that the consumable insert 30 is embedded into a top layer of a plurality of backing tiles 12. While the channel 13 is shown having a substantially rectangular cross section, the channel 13 and corresponding consumable insert 30 may be any shape suitable for performing the function of providing a partially consumable weld backing for large root gaps.

The consumable insert 30 may be consumed into the weld during a welding process, and may preferably include an elongate strip 32 embedded into a longitudinal center channel of one or more backing tiles 12 and one or more lateral strips 34 positioned in a spaced-apart manner on one or more backing tiles 12 (e.g., positioned along top and bottom edges of one or more backing tiles 12). Thus, the consumable insert 30 layer may form a lattice shape/pattern extending across large mismatched weld gaps to provide electrical conduction between the mating parts and welding process. In preferred embodiments, the consumable insert 30 is configured to be consumed into the weld puddle and does not adversely affect the integrity of the weld. The consumable insert 30 may also allow for electrical conduction between the matting parts and welding process. Specifically, the elongate strip may be the main consumable portion of the consumable insert 30, while the lateral or transverse sections may close the circuit between the mating parts.

The consumable insert 30 is preferably formed from one or more alloy metals so as to obtain a weld bead composition which is similar to the composition of or is a desired composition for the one or more metal components which are being welded together. A weld bead having a composition that closely matches the composition of the one or more metal components 40, 42 typically forms a strong, durable, high quality weld bead. In one non-limiting embodiment of the disclosure, the consumable insert 30 is formed of mild steel, low carbon steel or stainless steel, or some other type of metal or metal alloy. As can be appreciated, the insert can be formed of other metals. The composition of the consumable insert 30 may optionally be selected to be similar to the base metal component of the metal component sections. In some embodiments, the consumable insert 30 may include one or more metal alloying agents used to facilitate in customizing the composition of the formed weld bead to achieve the desired characteristics of the weld bead. In such embodiments, the insert 30 may be formed of mild steel or other such material such that alloying agents used in the weld in combination with the composition of the consumable insert 30 form a weld bead having a composition substantially similar to the metal composition of the metal components 40, 42 and/or form a weld bead having specific mechanical properties for use in a particular application.

The consumable insert 30 may be embedded into a top layer of the backing tile 12 such that a top surface of the consumable insert 30 is exposed and is configured to contact a portion of each of the two spaced-apart metal components 40, 42. In some embodiments, as shown in FIG. 2, the top surface of the consumable insert 30 may be flush with a top surface of the ceramic tile. In some embodiments, as shown in FIG. 3, the top surface of the consumable insert 30 may extend above a top surface of the ceramic tile. The consumable insert 30 may be formed with a thickness of between 1 mm and 5 mm. The consumable insert 30 may be configured to provide electrical conduction between the two spaced-apart metal articles and weld material used during a weld. The one or more lateral strips are configured to close a circuit between the two spaced-apart metal articles. The consumable insert 30 may be consumed into a weld puddle during the weld. The consumable insert 30 may be composed of one or more alloy metals that do not adversely affect a weld bead composition of a weld bead formed to join the two spaced-apart metal articles during the weld.

The backing assembly 10 may be configured to form a straight edge on the tack weld. As shown in FIG. 2, during use in a welding process, the top surface 14 of the backing assembly 10 may be in contact with the bottom surface of the first and second metal component sections 40, 42. Also in the welded assembly 10, the backing assembly 10 may be in contacting relationship with at least one of the first and second metal component sections 40, 42. Also in the backing assembly 10, the top surface of the backing tiles 12 may be generally co-planar with the bottom surfaces of the metal components. Since it is necessary to position them so as to permit the filling of a welding groove, such as by bridging the groove at the bottom of a horizontal weld, or at the sides of a vertical weld, it is desirable to place the ceramic backing tiles 12 on a bar, preferably a channel which can contain the blocks. The backing assembly 10 may also be formed to engage with an inclined end joint to cut down metal leakage. While dimensions of the backing assembly 10 will depend on the size of the weld groove, for small grooves, they can be conveniently made about ½ to 2 inches wide by ½ inch thick and of the order of about 6 to 12 inches long.

In some embodiments, an adhesive means may be coupled to the backing assembly 10 (e.g., along the lengthwise edge of a series of tiles), and may be used to secure the backing assembly 10 to the metal articles during welding. In some embodiments, the adhesive means is a heat resistant adhesive (e.g., an aluminum tape) and may be used to attach the backing assembly 10 to the metal articles and secure the backing assembly 10 in place during the welding operation. In some embodiments, the heat resistant adhesive is a pressure sensitive adhesive tape that may be applied to the undersurface of the backing tile. The adhesive means may extend outward laterally from the block to attach to areas of the metal articles beyond the lateral boundaries of the backing assembly 10. The use of such adhesive means may also aid in restricting air from entering the welding area during welding, and permit the backing tiles 12 to be readily removed from the welded articles after welding.

FIG. 5 illustrates a flowchart of a method 50 for forming a backing assembly according to embodiments of the present disclosure. Method 50 may include forming 52 a backing tile assembly configured to be applied to the underside of a seam between adjacent edges of two spaced-apart metal articles which are to be welded together. The backing tile assembly including a plurality of individual backing tiles and further configured to be aligned beneath the seam between the adjacent edges of the articles to support molten weld metal. The method 50 may also include forming 54 a centrally aligned elongate channel within a top layer of the backing tile assembly that substantially spans the length of the backing tile assembly. The method 50 may further include forming 56 a plurality of transverse channels, including forming 58 at least one transverse channel within an upper region of the top layer of the backing tile and forming 60 at least one transverse channel within a lower region of the top layer of an individual backing tile. The method 50 may also include forming 62 a consumable metal insert configured to be embedded into the top layer of the backing tile, which may include forming 64 an elongate strip configured to be embedded into the centrally aligned elongate channel and forming 66 one or more lateral strips configured to be embedded into corresponding lateral channels formed within the top layer of the backing tile. The method 50 may then include embedding 68 the consumable metal insert into the top layer of the backing tile.

### INDUSTRIAL APPLICABILITY

An elongated continuous ceramic weld backing assembly 10, including one or more backing tiles 12 is described herein. The backing tiles 12 may be articulately interconnected in end-to-end relation, and retained in an operative position with respect to a weld seam line between adjacently disposed edges and of generally plate-like workpieces, respectively. In some instances, the interconnected backing assembly 10 may be retained in an operative position with respect to the seam line by means of a series of releasably attachable brackets (not shown).

According to the foregoing, the backing assembly 10 also includes a consumable insert 30. Using such a backing assembly 10 may be appropriate or desirable in many scenarios. For example, in the case where the open root weld joint, is excessively wide, the backing assembly may be utilized to form a portion of the weld pool. The backing assembly 10 can also be used to form a weld bead in an open root at a variety of welding angles (e.g., vertical up, vertical down, etc.). The use of a backing assembly 10 as described enables the efficacious production of one-side welds and the root pass back-up of two-side welds in the conventional inert gas welding processes as conventionally known in the industry. Additionally, prior to a welding process, the metal component edges 44, 46 may be positioned and secured together, typically by clamps until at least the root bead is applied to the gap between the metal component edges 44, 46, thereby filling the gap. While the spaced-apart edges 44, 46 of the metal component sections 40, 42 may typically be less than about ±1 mm apart, in some embodiments a wider gap exists. During a welding cycle, an electrode may be utilized to create the root bead. In such embodiments, a metal component ground may engage the metal component sections and the consumable insert 30 to complete the arc circuit between the electrode and the metal component section. The electrode may be directed into the gap between the two metal component sections (e.g., using an electrode tip). During the welding cycle, the electrode may be fed through an electrode tip so as to transfer the molten metal at the end of the electrode into the gap between the metal component sections to form a root bead.

A backing assembly 10 in accordance with the present disclosure can also be used in large fabrications or weldments. This segment includes heavy plate fabricators to pipe welding firms. The backing assembly 10 can be used in both manual and robotic open root welding operations. The backing assembly 10 may improve the arc start ability of any robotic process.

It will be apparent to those skilled in the art that various modifications and variations can be made to the disclosed weld backing assembly. Other embodiments will be apparent to those skilled in the art from consideration of the specification and practice of the disclosed weld backing assembly. It is intended that the specification and examples be considered as exemplary only, with a true scope being indicated by the following claims and their equivalents.

What is claimed is:

1. A weld backing assembly comprising:
a backing tile configured to be applied to the underside of a seam between adjacent edges of two spaced-apart metal articles which are to be welded together, the backing tile further configured to be aligned beneath the seam between the adjacent edges of the articles to support molten weld metal, the backing tile including a centrally aligned longitudinal center channel formed within a center region of a top layer of the backing tile and one or more lateral channels formed within the top layer of the backing tile; and
a consumable metal insert including an elongate strip configured to be embedded into the centrally aligned longitudinal center channel and one or more lateral strips embedded into the one or more lateral channels.

2. The weld backing assembly of claim 1, wherein the consumable metal insert is embedded into a top layer of the backing tile such that a top surface of the consumable metal insert is exposed and is configured to contact a portion of each of the two spaced-apart metal articles.

3. The weld backing assembly of claim 2, wherein the top surface of the consumable metal insert is flush with a top surface of the ceramic tile.

4. The weld backing assembly of claim 2, wherein the top surface of the consumable metal insert extends above a top surface of the ceramic tile.

5. The weld backing assembly of claim 1, wherein the consumable metal insert has a thickness of between 1 mm and 5 mm.

6. The weld backing assembly of claim 1, wherein the consumable insert provides electrical conduction between the two spaced-apart metal articles and weld material used during a weld.

7. The weld backing assembly of claim 6, wherein the one or more lateral strips are configured to close a circuit between the two spaced-apart metal articles.

8. The weld backing assembly of claim 6, wherein the consumable metal insert is consumed into a weld puddle during the weld.

9. The weld backing assembly of claim 6, wherein the consumable insert is composed of one or more alloy metals that do not adversely affect a weld bead composition of a weld bead formed to join the two spaced-apart metal articles during the weld.

10. The weld backing assembly of claim 1, further comprising:
heat resistant pressure sensitive adhesive tape applied to the undersurface of the backing tile and extending laterally from the block, wherein the heat resistant pressure sensitive adhesive tape is configured to be secured to the articles to hold the backing tile in position beneath the seam.

11. A method for forming a weld backing assembly comprising:
forming a backing tile assembly configured to be applied to the underside of a seam between adjacent edges of two spaced-apart metal articles which are to be welded together, the backing tile assembly including a plurality of individual backing tiles and further configured to be aligned beneath the seam between the adjacent edges of the articles to support molten weld metal;
forming a centrally aligned elongate channel within a top layer of the backing tile assembly, wherein the centrally aligned elongate channel spans the length of the backing tile assembly;
forming a plurality of transverse channels within a top layer of the backing tile assembly, including forming at least one transverse channel within an upper region of the top layer of at least one of the plurality of individual backing and forming at least one transverse channel within a lower region of the top layer of at least one of the plurality of individual backing tiles;
forming a consumable metal insert configured to be embedded into the top layer of the backing tile assembly, including forming an elongate strip configured to be embedded into the centrally aligned elongate channel and forming one or more lateral strips configured to be embedded into corresponding lateral channels formed within the top layer of the backing tile assembly; and
embedding the consumable metal insert into the top layer of the backing tile assembly.

12. The method of claim 11, wherein the consumable metal insert is embedded into a top layer of the backing tile such that a top surface of the consumable metal insert is exposed and is configured to contact a portion of each of the two spaced-apart metal articles.

13. The method of claim 12, wherein the top surface of the consumable metal insert is flush with a top surface of the ceramic tile.

14. The method of claim 12, further comprising:
forming a top surface of the consumable metal insert to extend above the top surface of the ceramic tile.

15. The method of claim 11, further comprising:
forming the consumable metal insert has a thickness of between 1 mm and 5 mm.

16. The method of claim 11, further comprising:
forming the consumable insert to provide electrical conduction between the two spaced-apart metal articles and weld material used during a weld.

17. The method of claim 16, wherein the one or more lateral strips are configured to close a circuit between the two spaced-apart metal articles.

18. The method of claim 16, further comprising;
forming the consumable metal insert to be consumed into a weld puddle during the weld.

19. The method of claim 16, further comprising:
forming the consumable insert from at least one or more alloy metals that do not adversely affect a weld bead composition of a weld bead formed to join the two spaced-apart metal articles during the weld.

20. A weld backing assembly comprising:
a backing tile assembly configured to be applied to the underside of a seam between adjacent edges of two spaced-apart metal articles which are to be welded together, the backing tile assembly is further configured to be aligned beneath the seam between the adjacent edges of the articles to support molten weld metal, the backing tile assembly including:
a centrally aligned elongate channel spanning the length of the backing tile assembly; and
one or more transverse channels formed within a top layer of the backing tile assembly, wherein a first transverse channel may be formed within a top layer of a first backing tile and a second transverse channel may be formed within a top layer of a second backing tile that is spaced apart from the first backing tile by at least a third backing tile; and
a consumable metal insert embedded into the top layer of the backing tile, the consumable metal insert including an elongate strip configured to be embedded into the centrally aligned elongate channel and one or more lateral strips configured to be embedded into corresponding transverse channels formed within the first and second the backing tiles.
